(19) United States
(12) Patent Application Publication
(10) Pub. No.: US 2020/0376479 A1
(43) Pub. Date: Dec. 3, 2020

(54) Ion Conducting Membranes With Low Carbon Dioxide Crossover

(71) Applicant: Dioxide Materials, Inc., Boca Raton, FL (US)

(72) Inventor: Richard I. Masel, Boca Raton, FL (US)

(21) Appl. No.: 16/429,868

(22) Filed: Jun. 3, 2019

(51) Int. Cl. B01J 41/14; C25B 9/10; C25B 1/10; C25B 13/08; B01J 47/12; B01J 39/18

(52) U.S. Cl. CPC B01J 41/14; C25B 9/10; B01J 39/18; C25B 13/08; B01J 47/12; C25B 1/10

(57) ABSTRACT

An ion conducting membrane comprises an anion exchange layer, a cation exchange layer, and at least one flow channel formed between the anode exchange layer and the cation exchange layer. The anion exchange layer contacts the cation exchange layer. The resulting membrane exhibits low carbon dioxide crossover.

### CROSS-REFERENCE TO RELATED APPLICATIONS

The present application is related to U.S. patent application Ser. No. 15/810,106 filed Nov. 12, 2017, entitled “Ion-Conducting Membranes”. The '106 patent is a continuation-in-part of U.S. patent application Ser. No. 15/400,775 filed on Jan. 6, 2017, entitled “Ion-Conducting Membranes” (now U.S. Pat. No. 9,849,450 issued on Dec. 26, 2017). The '775 application is, in turn, a continuation in part of U.S. patent application Ser. No. 15/090,477 filed on Apr. 4, 2016, entitled “Ion-Conducting Membranes” (now U.S. Pat. No. 9,580,824 issued on Feb. 28, 2017). The '477 application is, in turn, a continuation-in-part of U.S. patent application Ser. No. 14/704,935 filed on May 5, 2015, entitled “Ion-Conducting Membranes” (now U.S. Pat. No. 9,370,773 issued on Jun. 21, 2016). The '935 application is, in turn, a continuation-in-part of International Application No. PCT/US2015/14328, filed on Feb. 3, 2015, entitled “Electrolyzer and Membranes”. The '328 international application claimed priority benefits, in turn, from U.S. provisional patent application Ser. No. 62/066,823, filed on Oct. 21, 2014.

The '935 application is also a continuation-in-part of International Application No. PCT/US2015/26507 filed on Apr. 17, 2015, entitled “Electrolyzer and Membranes”. The '507 international application also claimed priority benefits, in turn, from U.S. provisional patent application Ser. No. 62/066,823 filed Oct. 21, 2014.

The '106 application, the '775 application, the '477 application, the '935 application, the '823 provisional application, and the '328 and '507 international applications are each hereby incorporated by reference herein in their entirety.

This application is also related to U.S. patent application Ser. No. 14/035,935 filed Sep. 24, 2013, entitled “Devices and Processes for Carbon Dioxide Conversion into Useful Fuels and Chemicals” (now U.S. Pat. No. 9,370,733); U.S. patent application Ser. No. 12/830,338 filed Jul. 4, 2010, entitled “Novel Catalyst Mixtures”; International application No. PCT/2011/030098 filed Mar. 25, 2011, entitled “Novel Catalyst Mixtures”; U.S. patent application Ser. No. 13/174,365 filed Jun. 30, 2011, entitled “Novel Catalyst Mixtures”; International application No. PCT/US2011/042809 filed Jul. 1, 2011, entitled “Novel Catalyst Mixtures”; U.S. patent application Ser. No. 13/530,058 filed Jun. 21, 2012, entitled “Sensors for Carbon Dioxide and Other End Uses”; International application No. PCT/US2012/043651 filed Jun. 22, 2012, entitled “Low Cost Carbon Dioxide Sensors”; and U.S. patent application Ser. No. 13/445,887 filed Apr. 12, 2012, entitled “Electrocatalysts for Carbon Dioxide Conversion”.

### STATEMENT OF GOVERNMENT INTEREST

This invention was made, at least in part, with U.S. government support under U.S. Department of Energy Grant No. DE-SC0018540. The government has certain rights in the invention.

### FIELD OF THE INVENTION

The field of the invention is electrochemistry. The devices, systems and compositions described herein involve the electrochemical conversion of carbon dioxide into useful products, the electrolysis of water, electric power generation using fuel cells and electrochemical water purification.

### BACKGROUND OF THE INVENTION

There is a present need to decrease carbon dioxide (CO₂) emissions from industrial facilities. Over the years, several electrochemical processes and devices have been suggested for the conversion of CO₂ into useful products. The devices usually employ electrochemical cells with an anode and cathode, with an ion conducting membrane disposed between the anode and the cathode.

During operation, gaseous CO₂ or CO₂ dissolved in an electrolyte is fed into the cathode of the cell, where some of the CO₂ is converted into products such as CO, HCO⁻, H₂CO, (HCOO)⁻, HCOOH, CH₃OH, CH₄, C₂H₄, CH₃CH₂OH, CH₃COO⁻, CH₃COOH, C₂H₆, (COOH)₂, (COO—)₂, and CF₃COOH.

Unfortunately, some of the CO₂ and other products cross through the membrane, and are wasted.

Mathews et al. U.S. Patent Application Publication No. 2017/0183789; Kuhl et al. U.S. Patent Application Publication No. 2017/0321334, Zhou et al. ACS Energy Letters 1, 764 (2016), Li et al. ACS Energy Letters 1, 1149-1153 (2016), Li et al. Advanced Sustainable Systems, 2, 1700187 (2018), Berlinguette et al. International Publication No. WO 2019/051609, Salvatore et al, ACS Energy Letters, 3 149-154 (2018) Pãtru, et al, J. Electrochemical Soc., 166 F34-F43 (2019) (the Pãtru paper) all show that bipolar membranes are effective in reducing CO₂ crossover in such systems, where a bipolar membrane is an ion conducting membrane comprising anion exchange layer and a cation exchange layer.

Unfortunately, electrochemical cells using membranes reported by Mathews, Zhou, Li, Pãtru do not show stable long-term performance. For example, the Pãtru paper shows rapid loss of the activity in the first 5 hours of performance, which is not commercially viable.

The key issue is that CO₂ bubbles form at the interface between the anion exchange layer and cation exchange layer. The bubbles grow, reducing the conductivity of the membrane. Eventually the membrane fails.

The Pãtru paper shows that performance can be recovered by stopping the cell and allowing it to “rehydrate” for hours. The CO₂ bubbles are slowly removed during the rehydration process, but stopping the cell every few hours to rehydrate is not commercially viable.

### SUMMARY OF THE INVENTION

A new bipolar design avoids the membrane failures and loss of performance associated with CO₂ bubbles in conventional bipolar membranes. Generally, the device comprises a bipolar membrane wherein there is a means to remove the CO₂ bubbles that form at the interface between the anion and cation exchange layers in the bipolar membrane.

In a preferred embodiment, the ion conducting membrane comprises:

(a) an anion exchange layer;

(b) a cation exchange layer; and

(c) at least one flow channel formed between the anode exchange layer and the cation exchange layer.

The anion exchange layer contacts the cation exchange layer.

In a preferred embodiment, the anion exchange layer comprises an anion exchange polymer and the cation exchange layer comprises a cation exchange polymer.

In a preferred embodiment, the flow channels are formed in at least one of the anion exchange layer or the cation exchange layer.

Preferably, the flow channel(s) are at least 1 micron deep, more preferably at least 5 micron deep, most preferably at least 10 microns deep.

Preferably, the flow channels are no more than 20 mm spaced apart center-to-center, more preferably no more than 10 mm spaced apart center-to-center, more preferably no more than 5 mm spaced apart center-to-center, most preferably said flow channels are no more than 3 mm spaced apart center-to-center.

Preferably, the cation exchange polymer is a proton exchange polymer.

Preferably, the anion exchange polymer comprises a benzyl group bonded to at least one of: an imidazolium, a pyridinium, a pyrazolium, a pyrrolidinium, a pyrrolium, a pyrimidium, a piperidinium, an indolium, a triazinium, a phosphonium or a quaternary amine.

### BRIEF DESCRIPTION OF THE DRAWINGS

FIG. 1 is a schematic depiction of the bipolar membrane described herein.

FIG. 2 is a photograph of a Nafion 117 membrane 201 that has flow channels formed therein as described in Specific Example 1 below. The membrane has a series of ˜15 micron deep channels or grooves 211-218. The grooves are 0.86 mm wide and are 2.25 mm spaced apart center to center.

FIG. 3 is a plot showing how the cell current 301 and cell voltage 302 varied with time during the constant current run described in Specific Example 1 below.

FIG. 4 is a plot showing how the ratio of the CO₂ peak and the O₂ peak varied with time during the constant current run described in Specific Example 1 below.

### DETAILED DESCRIPTION OF ILLUSTRATIVE EMBODIMENT(S)

The invention disclosed herein is not limited to the particular methodology, protocols, and reagents described herein, as these can vary as persons familiar with the technology involved here will recognize. The terminology employed herein is used for the purpose of describing particular embodiments only and is not intended to limit the scope of the invention. As used herein and in the appended claims, the singular forms “a,” “an,” and “the” include the plural reference unless the context clearly dictates otherwise. Thus, for example, a reference to “a linker” is a reference to one or more linkers and equivalents thereof known to persons familiar with the technology involved here.

Unless defined otherwise, all technical and scientific terms used herein have the same meanings as commonly understood by persons familiar with the technology involved here. The embodiments of the invention and the various features and advantageous details thereof are explained more fully with reference to the non-limiting embodiments and/or illustrated in the accompanying drawings and detailed in the following description, where the term “and/or” signifies either one or both of the options. It should be noted that the features illustrated in the drawings are not necessarily drawn to scale, and features of one embodiment can be employed with other embodiments as persons familiar with the technology involved here would recognize, even if not explicitly stated herein.

Any numerical value ranges recited herein include all values from the lower value to the upper value in increments of one unit provided that there is a separation of at least two units between any lower value and any higher value. As an example, if it is stated that the concentration of a component or value of a process variable such as, for example, size, angle size, pressure, time and the like, is, for example, from 1 to 90, specifically from 20 to 80, more specifically from 30 to 70, it is intended that values such as 15 to 85, 22 to 68, 43 to 51, 30 to 32, and so on, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value are to be treated in a similar manner.

Moreover, provided immediately below is a “Definitions” section, where certain terms related to the invention are defined specifically. Particular methods, devices, and materials are described, although any methods and materials similar or equivalent to those described herein can be used in the practice or testing of the invention. All references referred to herein are incorporated by reference herein in their entirety.

### Definitions

The term “polymer electrolyte membrane” refers to both cation exchange membranes, which generally comprise polymers having multiple covalently attached negatively charged groups, and anion exchange membranes, which generally comprise polymers having multiple covalently attached positively charged groups. Typical cation exchange membranes include proton conducting membranes, such as the perfluorosulfonic acid (PFSA) polymer available under the trade designation NAFION from E. I. du Pont de Nemours and Company (DuPont) of Wilmington, Del.

The terms “anion exchange membrane” and “anion exchange layer” as used here refer to membranes comprising polymers wherein the polymers comprise positively charged groups.

The term “cation exchange membrane” and “cation exchange layer” as used here refer to membranes comprising polymers wherein the polymers comprise negatively charged groups.

The term “cation exchange polymer” as used here refer to polymers comprising negatively charged groups

The term “anion exchange polymer” as used here refer to polymers comprising positively charged groups

The term “bipolar membrane” as used here refers to an ion exchange membrane comprising an anion exchange layer and a cation exchange layer.

The term “electrochemical conversion of CO₂” as used here refers to any electrochemical process where carbon dioxide, carbonate, or bicarbonate is converted into another chemical substance in any step of the process.

The term “MEA” as used here refers to a membrane electrode assembly.

The term “imidazolium” as used here refers to a positively charged ligand containing an imidazole group. This includes a bare imidazole or a substituted imidazole. Ligands of the form:

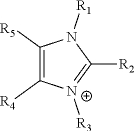

where R₁—R₅ are each independently selected from hydrogen, halogens, linear alkyls, branched alkyls, cyclic alkyls, heteroalkyls, aryls, cyclic aryls, heteroaryls, alkylaryls, heteroalkylaryls, and polymers thereof, such as the vinyl benzyl copolymers described herein, are specifically included.

The term “pyridinium” as used here refers to a positively charged ligand containing a pyridinium group. This includes a protonated bare pyridine or a substituted pyridine or pyridinium. Ligands of the form:

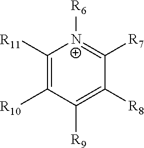

where R₆—R₁₁ are each independently selected from hydrogen, halogens, linear alkyls, branched alkyls, cyclic alkyls, heteroalkyls, aryls, cyclic aryls, heteroaryls, alkylaryls, heteroalkylaryls, and polymers thereof, such as the vinyl benzyl copolymers described herein, are specifically included.

The term “pyrazoliums” as used here refers to a positively charged ligand containing a pyrazolium group. This includes a bare pyrazolium or a substituted pyrazolium. Ligands of the form:

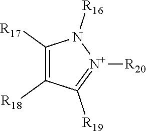

where R₁₆—R₂₀ are each independently selected from hydrogen, halogens, linear alkyls, branched alkyls, cyclic alkyls, heteroalkyls, aryls, cyclic aryls, heteroaryls, alkylaryls, heteroalkylaryls, and polymers thereof, such as the vinyl benzyl copolymers described herein, are specifically included.

The term “phosphonium” as used here refers to a positively charged ligand containing phosphorous. This includes substituted phosphorous. Ligands of the form:

P⁺(R₁₂R₁₃R₁₄R₁₅)

where R₁₂—R₁₅ are each independently selected from hydrogen, halogens, linear alkyls, branched alkyls, cyclic alkyls, heteroalkyls, aryls, cyclic aryls, heteroaryls, alkylaryls, heteroalkylaryls, and polymers thereof, such as the vinyl benzyl copolymers described herein, are specifically included.

The term “positively charged cyclic amine” as used here refers to a positively charged ligand containing a cyclic amine. This specifically includes imidazoliums, pyridiniums, pyrazoliums, pyrrolidiniums, pyrroliums, pyrimidiums, piperidiniums, indoliums, triaziniums, and polymers thereof, such as the vinyl benzyl copolymers described herein.

Specific Description

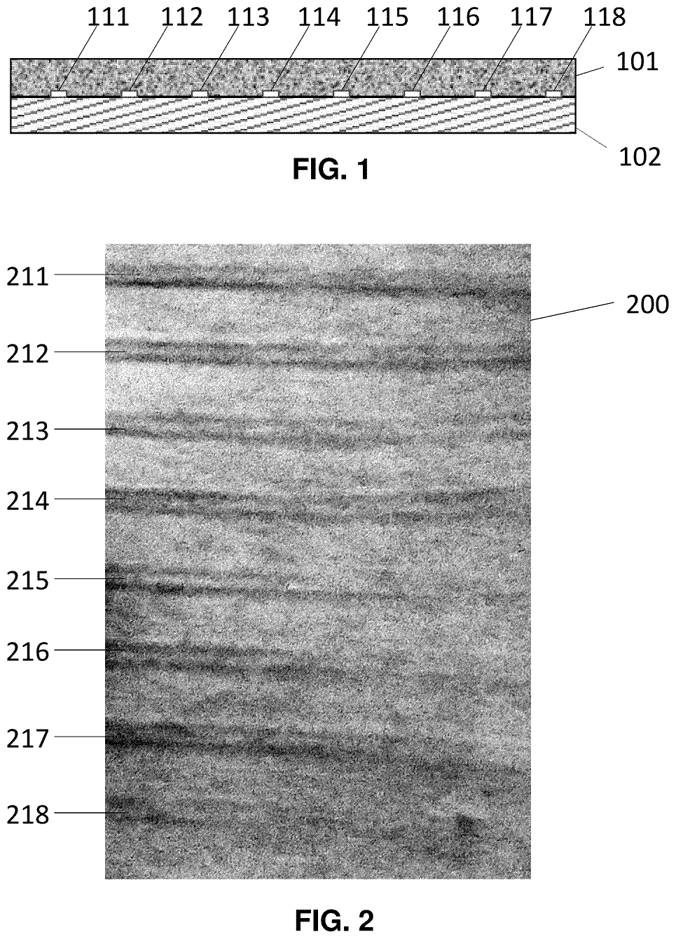

FIG. 1 is a diagram of a bipolar membrane having channels formed therein. The membrane comprises a cation exchange layer 101 contacting an anion exchange layer 102. A series of channels 111, 112, 113, 114, 115, 116, 117, 118 is formed at the interface of cation exchange layer 101 and anion exchange layer 102. The channels provide a flow path for the removal of CO₂ bubbles from the interface between the layers. The channels are preferably less than 10 mm apart center-to-center and are at least 1 micron deep.

FIG. 1 shows channels formed in the cation exchange layer, but the channels can also be formed in the anion exchange layer. The channels can have a variety of cross-sectional shapes including rectangles, quadrilaterals with straight or rounded edges, arcs and semicircles.

### Specific Example 1: Synthesis of a Suitable Membrane

A standard PFSA membrane (Nafion 115, Ion Power, Newark Del.) was passed through a roll die to create a series of ˜15 micron deep groves. The grooves are 0.86 mm wide and are spaced apart 2.25 mm center to center.

FIG. 2 shows a photograph of a Nafion membrane 201 with a series of grooves 211-218 formed in the membrane.

Next, an anion conducting membrane (Sustainion X-37 Dioxide Materials, Boca Raton Fla.) was soaked in 1 M KOH overnight, and surface water was removed with a towel. The Nafion membrane was then laminated onto the Sustainion membrane with a hot press.

The resultant membrane was sandwiched between a Dioxide Materials cathode electrode for carbon dioxide electrolyzer SKU 68756 and a Dioxide Materials anode electrode for carbon dioxide electrolyzer SKU 68749, and then mounted in Fuel Cell Technologies 5 cm² cell hardware. On the cathode side, humidified CO₂ was fed into the cathode flow field at a flow rate of 30 mL/min. On the anode side, 20 mM KHCO₃ solution was fed into the anode flow field at a flow rate of 3 mL/min. To operate the cell, a BK Precision 9110 power supplier was used. The cell was first operated at a constant voltage mode at −3.5V and then switched to a constant current mode after the current reached 500 mA. The gas products from both anode and cathode sides were analyzed using a gas chromatography (GC) system (Agilent 6890).

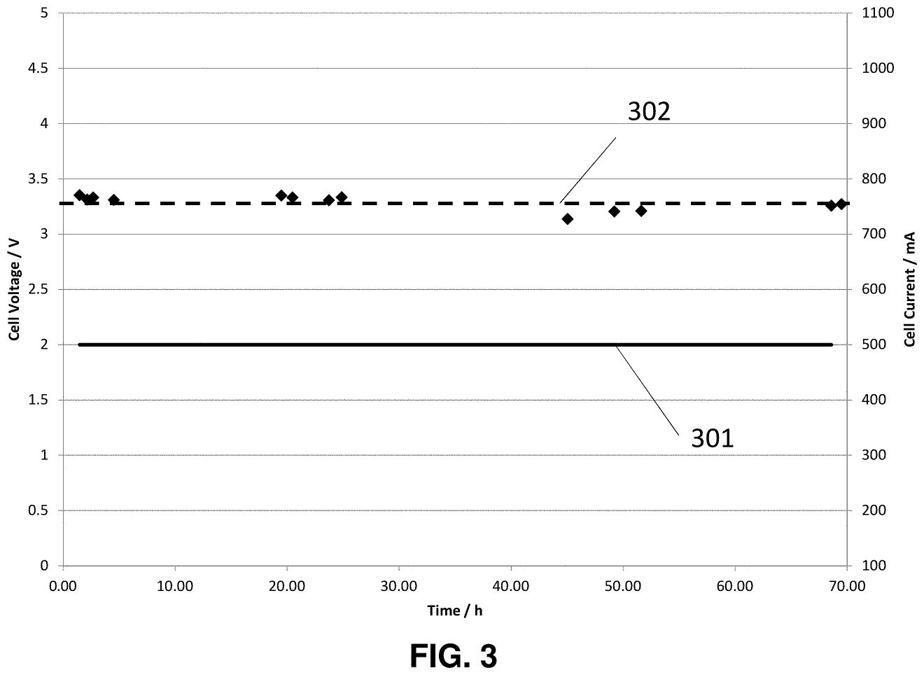

FIG. 3 shows how the current and voltage varied during the run. Note that the current and voltage are stable. By comparison, the Pãtru paper shows that the current produced using a similar cell and a membrane without the channels decays in only 5 hours. The formation of channels in the membrane is a clear improvement.

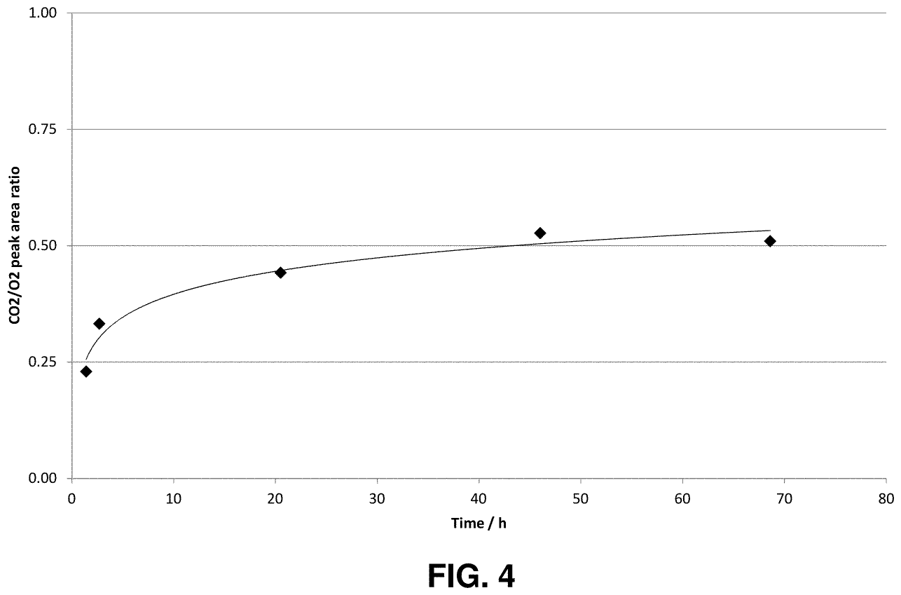

An Agilent 6890 GC was used to analyze gas product produced on the anode. First a GC trace was taken and the area of the CO₂ and O₂ peaks in the trace was measured. The ratio of the CO₂ peak area to the O₂ peak area was then calculated. FIG. 4 shows the results. Initially the CO₂ peak is only 25% of the O₂ peak. At steady state the CO₂ peak is about 50% of the O₂ peak. By comparison, if we use the Sustainion® membrane by itself, the CO₂ peak is between 350 and 400% of the oxygen peak. Clearly, the CO₂ crossover has been reduced by the membrane.

The example above used 15 micron deep channels. Channels less than 1 micron deep channels can also be fabricated, but they tend to be blocked when the membrane swells, so they are less effective. No blockage is seen if the channels are at least 1 micron deep, preferably 5 microns deep, more preferable 10 microns deep.

The channels in this example were formed in the cation exchange layer, but they can also be formed in the anion exchange layer.

The example described here used a Sustainion® 37 membrane. Sustainion® 37 consists of a copolymer of vinylbenzyl chloride and styrene that has been functionalized with tetramethyl imidazole to yield a tetramethyl imidazolium ligand. Other anion exchange polymers in the anion exchange layer can be used instead, including in particular a polymer comprising a benzyl group that is bonded to imidazoliums, pyridiniums, pyrazoliums, pyrrolidiniums, pyrroliums, pyrimidiums, piperidiniums, indoliums, triaziniums, phosphoniums, or quaternary amines.

The example given above is illustrative and is not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the chemical arts or in the relevant fields are intended to be within the scope of the appended claims.

The disclosures of all references and publications cited above are expressly incorporated by reference in their entireties to the same extent as if each were incorporated by reference individually.

While particular elements, embodiments and applications of the present invention have been shown and described, it will be understood that the invention is not limited thereto since modifications can be made by those skilled in the art without departing from the scope of the present disclosure, particularly in light of the foregoing teachings.

1. A bipolar ion conducting membrane comprising:
(a) an anion exchange layer;
(b) a cation exchange layer;
(c) at least one flow channel formed in at least one of said anode exchange layer and said cation exchange layer,
wherein said anion exchange layer physically contacts said cation exchange layer.

2. The membrane of claim 1, wherein said anion exchange layer comprises an anion exchange polymer and said cation exchange layer comprises a cation exchange polymer.

3. (canceled)

4. The membrane of claim 3, wherein said at least one flow channel is at least 1 micron deep.

5. The membrane in claim 4, wherein said at least one flow channel is at least 5 microns deep.

6. The membrane in claim 5, wherein said at least one flow channel is at least 10 microns deep

7. The membrane of claim 3, wherein said at least one flow channel is a plurality of flow channels, said flow channels no more than 20 mm apart center-to-center.

8. The membrane of claim 7, wherein said flow channels are no more than 10 mm apart center-to-center.

9. The membrane of claim 8, wherein said flow channels are no more than 5 mm apart center-to-center.

10. The membrane of claim 9, wherein said flow channels are no more than 3 mm apart center-to-center.

11. The membrane of claim 2, wherein said cation exchange polymer is a proton exchange polymer.

12. The membrane of claim 2, wherein said anion exchange polymer comprises a benzyl group bonded to at least one of: an imidazolium, a pyridinium, a pyrazolium, a pyrrolidinium, a pyrrolium, a pyrimidium, a piperidinium, an indolium, a triazinium, a phosphonium or a quaternary amine.

13. The membrane of claim 12, wherein said anion exchange polymer comprises a benzyl group bonded to at least one of: an imidazolium, a pyridinium, a pyrazolium, a pyrrolidinium, a pyrrolium, a pyrimidium, a piperidinium, a phosphonium or a quaternary amine.

14. The membrane of claim 13 wherein said anion exchange polymer comprises a benzyl group bonded to at least one of: an imidazolium, a pyridinium, a pyrrolidinium, a piperidinium or a quaternary amine.

15. An electrochemical device comprising the membrane of claim 1.

16. The electrochemical device of claim 15, further comprising:
an anode comprising a quantity of anode catalyst, said anode having an anode reactant introduced thereto via at least one anode reactant flow channel;
a cathode comprising a quantity of cathode catalyst, said cathode having a cathode reactant introduced thereto via at least one cathode reactant flow channel;
said membrane interposed between said anode and said cathode such that said cation exchange layer faces said anode and said anion exchange layer faces said cathode; and
a source of electrical energy configured to apply a potential difference across the anode and the cathode,
wherein said cathode is encased in a cathode chamber and at least a portion of the cathode catalyst is directly exposed to water or gaseous CO₂.
